(19) United States
(12) Patent Application Publication
(10) Pub. No.: US 2023/0392786 A1
(43) Pub. Date: Dec. 7, 2023

(54) METHOD FOR COMBUSTION OF A BIOLOGICAL MATERIAL AND A PROCESS FOR CREMATING A HUMAN OR ANIMAL BODY OR BODY PART

(71) Applicant: NEO JOULE B.V., MAASBRACHT (NL)

(72) Inventors: Andrew Charles DORN, MAASBRACHT (NL); Maria COSTA, MAASBRACHT (NL)

(21) Appl. No.: 18/031,945

(22) PCT Filed: Oct. 15, 2021
(86) PCT No.: PCT/NL2021/050625

§ 371 Date: Apr. 14, 2023

(30) Foreign Application Priority Data
Oct. 16, 2020 (NL) 2026692

(51) Int. Cl. F23G 1/00; H05B 6/70

(52) U.S. Cl. CPC F23G 1/00; H05B 6/707; F23G 2202/701; F23G 2900/7009; F23G 2204/203

(57) ABSTRACT

The present invention relates to a method for combustion of a biological material by means of microwave radiation, said method comprises providing said biological material to be combusted, wherein the biological material includes a human or animal body or body part, and optionally a container and an apparatus comprising a chamber and a source of microwave radiation; and directing microwave radiation at a power of at least 5 kW from said source of microwave radiation to said biological material to directly heat and combust said biological material in said chamber. The present invention further relates to a process for cremating a human or animal body or body part comprising said method.

### TECHNICAL FIELD

The present invention relates to a method for combustion of a biological material by means of microwave radiation. The invention further relates to a process for cremating a human or animal body or body part.

### BACKGROUND

Conventional cremators for the cremation of human bodies in coffins may vary considerably in their structural design but the heating means are invariably gas burners, oil burners or electrical heating elements.

Using such conventional heating techniques the heat for initiating and maintaining combustion is applied to the body externally and the outer layers of the body must be burnt before successively deeper layers can be exposed and consumed by the flames. Wherein body is referred to in the description, this can also be read as body part unless stated otherwise. A significant factor inhibiting the rate of combustion is the water content of a body. In the average human about 50 to 70% of the body weight is attributable to water. This moisture has to be driven off to a certain extent before the ignition temperature can be reached.

Retention of liquid water within the body prevents the temperature of the biological material from exceeding the so-called wet bulb temperature of the body material until an appreciable amount of evaporation as occurred and the body is relatively dry.

Due to the extreme heat required to evaporate the water from the body and successively combust the dried remains (dried biological material), a large part of the bodily flesh is blown into particulates and carried out of the combustion chamber with the present air/gases. These particulates must be then filtered out of the air/gases, since they may comprise harmful compounds including highly toxic, non-biodegradable dioxins that steadily accumulate in the environment.

Furthermore, because of the required high temperatures the cremation ovens are often heated continuously to avoid long heating and cooling periods, and reduce the amount of total energy required for heating. The ovens are often also heated in the periods between cremation processes and during the night. This requires a significant use of energy and fuel, which is undesirable from a cost and environmental perspective

GB2032596 from 1979 discloses a method for the cremation of human or animal remains wherein conventional heat sources (gas, oil etc.) are replaced or supplemented by microwave heating. Microwave pre-treatment may be followed by conventional heating. The use of microwave heating only is disclosed to be impractical because of the high power requirement.

DE4417701 from 1994 discloses a method for the cremation of human bodies. The method using weighing of the human remains prior and during the cremation process to control the heating curve of the furnace based on weight loss. The initial temperature is set in a range of approximately 500° C. and this is increased depending on the weight loss and the gases escaping from the furnace.

U.S. Pat. No. 5,886,326 A1 from 1996 discloses a method of incinerating garbage by preliminary microwave irradiation in vacuum, subsequent introduction of oxygen and continued irradiation to cause combustion. The method uses a silicon carbide shroud/cage surrounding the garbage to be incinerated, that is heated to a temperature of 500 to 1000° C. by absorption of microwave energy to ignite the material to be disposed of. The garbage to be combusted is indirectly heated by means of the susceptor; no direct heating is applied.

EP1212569 from 2000 discloses a process for the treatment of carbon containing material, such as coffins with bodies by irradiation with microwaves in an oxygen depleted atmosphere, followed by the introduction of oxygen or air, a combustible gas and igniting said mixture.

There is a need for a cremation process that is environmentally friendly and safe, energy efficient, and that does not require the use of fossil fuel.

### SUMMARY

It is an objective of the present invention to provide an improved method for combustion of a biological material.

It is a further objective of the present invention to provide a method for combustion of a biological material that is environmentally friendly.

It is a further objective of the present invention to provide a method for combustion of a biological material and/or a cremation process that is more energy efficient than currently used processes.

It is a further object of the present invention to provide a method for combustion of a biological material and/or a cremation process that does not require the use of fossil fuel.

The invention relates in a first aspect to a method for combustion of a biological material by means of microwave radiation, said method comprising the steps of:
i) providing said biological material to be combusted and an apparatus comprising a chamber and a source of microwave radiation in such a manner that said biological material is present in said chamber;
wherein the biological material includes a human or animal body or body part, and optionally a container;
ii) directing microwave radiation at a power of at least 5 kW, preferably at least 10 kW, from said source of microwave radiation to said biological material to directly heat and combust said biological material in said chamber.

The invention relates in a second aspect to a process for cremating a human or animal body or body part comprising the method of the first aspect.

With human body is meant the remains of a human being after its death. It also encompasses any clothing, internal prosthetics and optionally jewelry or other personal items that are provided with the human body when being cremated.

### List of Definitions

The following definitions are used in the present description and claims to define the stated subject matter. Other terms not cited below are meant to have the generally accepted meaning in the field.

“Combustion” as used in the present description means: a high-temperature exothermic redox chemical reaction between a fuel (the reductant), being the biological material, and an oxidant, usually oxygen, e.g. from air (atmospheric oxygen), that produces oxidised, often gaseous products, in a mixture termed as smoke as well as a solid residue.

“Spontaneous combustion” as used in the present description means: a type of combustion which occurs by self-heating (increase in temperature due to exothermic internal reactions), followed by thermal runaway (self-heating which rapidly accelerates to high temperatures) and finally, ignition.

“Ignition temperature” as used in the present description means: the lowest temperature at which combustion of the biological material starts.

“Pyrolysis” as used in the present description means: the thermal decomposition of materials at elevated temperatures in an inert atmosphere (e.g. an oxygen depleted atmosphere). This inert atmosphere may be a vacuum. Pyrolysis involves a change of chemical composition but is not an oxidation reaction.

“Microwaves” as used in the present description means: a form of electromagnetic radiation with wavelengths ranging from about one meter to one millimeter; with frequencies between 300 MHz (1 m) and 300 GHz (1 mm).

“Drying” as used in the present description means: reducing the water content of the biological material. For human bodies, the water content is generally at least 50% of the total weight. The water content varies with age, sex, height and weight, and the Watson formula may be used to estimate the water content:

Men: 2.447−(0.09145×age)+(0.1074×height in centimetres)+(0.3362×weight in kilograms)=total body water (TBW) in litres

Women: −2.097+(0.1069×height in centimetres)+(0.2466×weight in kilograms)=total body water (TBW) in litres

Because of these variations, the reduction in water content achieved during drying, as well as the water content after drying will vary as well.

“Dried biological material” as used in the present description means biological material from which a part of (or all) the water content has been removed. Even though the word “dried” is used within the context of this definition, the biological material as such is most often not completely dry but will contain a certain percentage of water. In other words, physically speaking it is partially dried and not completely dried in most events. Compared to the starting biological material, which is the human body (part(s)) or animal body (part(s)), the percentage of water is reduced to such an extent that the dried biological material can be ignited and combusted.

“Directly heating” as used in the present description means that the microwave radiation acts directly on the (dried) biological material as such.

“Indirect heating” as used in the present description means that the microwave radiation could act on an optional microwave radiation suspector, which increases in temperature which then in turn indirectly heats, through infra-red radiation, the (dried) biological material.

“Waveguides” as used in the present description means: a structure that guides waves, such as electromagnetic waves, with minimal loss of energy by restricting the transmission of energy to one direction. Without the physical constraint of a waveguide, wave amplitudes decrease according to the inverse square law as they expand into three dimensional space. There are different types of waveguides for different types of waves. The original and most common type of waveguide is a hollow conductive metal pipe used to carry high frequency radio waves, particularly microwaves.

“Susceptor” as used in the present description means: a material used for its ability to absorb electromagnetic energy and convert it to heat. Suitable susceptor materials include silicon carbide, graphite, metal oxides such as zirconium dioxide or magnetite, ferrite, and conductive metals (on glass or ceramic plates). A ferrite is a ceramic material made by mixing and firing large proportions of iron(III) oxide (Fe₂O₃, rust) blended with small proportions of one or more additional metallic elements, such as barium, manganese, nickel, and zinc.

“Silicon carbide” as used in the present description means: a semiconductor containing silicon and carbon. Silicon carbide (SiC) is also known as carborundum. Silicon carbide exists in about 250 crystalline forms. The major polytypes are 3C (β), 4H, and 6H (α).

### BRIEF DESCRIPTION OF DRAWINGS

The present invention is described hereinafter with reference to the accompanying drawings in which embodiments of the present invention are shown and in which like reference numbers indicate the same or similar elements.

FIG. 1 is a schematic view of an apparatus for use in the present method.

FIG. 2 shows the temperature evolution in a meat sample undergoing microwave radiation.

FIG. 3 shows the temperature evolution in a whole baby pig (piglet) undergoing the inventive combustion process.

FIG. 4 shows photographs of a whole baby pig (piglet) before and after the inventive combustion process.

FIG. 5 shows the temperature evolution in a coffin with body parts (shoulders) of a pig and three susceptors undergoing the inventive combustion process.

FIG. 6 shows photographs of a coffin with body parts (shoulders) of a pig and three susceptors before and after the inventive combustion process.

FIG. 7 shows the temperature evolution in a coffin with a whole baby pig undergoing the inventive combustion process.

FIG. 8 shows photographs of a coffin with a whole baby pig before and after the inventive combustion process.

### DESCRIPTION OF INVENTION AND EMBODIMENTS

The invention relates to a method for combustion of a biological material by means of microwave radiation. In a first aspect, the method comprises two steps. In a first step the method comprises providing: a) a biological material to be combusted and b) an apparatus comprising a chamber and a source of microwave radiation.

The present method is carried out in one single chamber, that is to say, the biological material is entered in the chamber and is removed from the chamber only once combusted. There are no dual chambers, i.e. one for drying and one for combustion.

The source of microwave radiation in the first or second aspect may be connected to at least one waveguide. When at least one waveguide is present, in an embodiment, a flow of gas is directed down the at least one waveguide during step ii) in order to prevent any arcing occurring inside said waveguides from gases/smoke originating from the combustion traveling up the waveguide. The flow of gas will flush out the smoke and prevent arcing. The gas may be air or may be (dry) nitrogen gas or a noble gas such as argon, preferably air. In an embodiment, the flow of gas going down the waveguide has a flow rate of at least 10 litres per second per waveguide.

The microwave radiation in the first or second aspect may be directed from said source of microwave radiation to said biological material and is of a single frequency. The microwave radiation in the first or second aspect may have a frequency between 1 MHz and 3 GHz. The microwave radiation in the first or second aspect may have a frequency between 100 MHz and 3 GHz. The microwave radiation in the first or second aspect may have a frequency between 500 MHz and 1.5 GHz. The microwave radiation in the first or second aspect may have a frequency between 700 MHz and 1.1 GHz.

The method and the process may comprise in step ii) a two-phase combustion process, wherein in a first phase of said combustion process said radiation directly heats said biological material to evaporate water from the biological material and obtain a dried biological material, and wherein in a second phase of said combustion process said radiation directly heats dried biological material (mainly comprising proteins and bones as well as some fat) to an ignition temperature, to combust said dried biological material and obtain combusted biological material.

The microwave radiation in the first or second aspect may be applied from the beginning of step ii) at least until the point of ignition of said biological material.

In an embodiment, the microwave radiation remains switched on during combustion. The present inventors have observed that in certain embodiments, e.g. when no combustable container is present, additional energy is desirable to aid the combustion and to prevent the flames from dying out in lower air flow conditions. It can thus be desirable to add additional energy/fuel; this might be provided through a combustible container (e.g. wooden coffin), the use of a microwave absorbing susceptor (as discussed in detail above), or by keeping the microwave power switched on during the combustion process.

In an embodiment, the microwave power remains switched on during the combustion, optionally at a lower power level such as at least 5 kW (e.g. between 10 kW to 30 kW, such 10 kW to 20 kW) during the combustion phase. If the microwave power is kept switched on, the power may be reduced after ignition. It was observed by the present inventors, that using the same power after ignition as before ignition might cause unwanted arcing in the waveguides, which might lead to breakage of the microwave source. In an embodiment, arc detectors are added to the apparatus to regulate the power whenever arc in waveguides is detected. The microwave power can be (or is) switched off after combustion is complete, e.g. when the cooling phase starts. When ignition has started, there is a gas plasma interaction between the microwaves and the flames. As a result, microwaves enhance the combustion.

In another embodiment, the microwave radiation is switched off after ignition, wherein said biological material comprises a human or animal body or body part and a container; the combustion of said container, in particular a wooden coffin, providing sufficient additional energy to keep the combustion going.

The method or process may take place under atmospheric pressure. The method or process will preferably take place in the presence of oxygen, preferably air.

The method or process may include the step of determining the starting weight of the biological material to determine the energy level of the microwave radiation. The method or process may include the step of determining the starting weight of the biological material to determine the duration for direction of microwave radiation. The method or process may include the step of determining the starting weight of the biological material to determine the energy level of the microwave radiation and the duration for direction of microwave radiation. Depending on the starting weight a combustion program with certain microwave power settings may be selected.

The biological material according to the first or second aspect may include a human body or one or more human body parts or one or more combinations thereof. The biological material according to the first or second aspect may include an animal body or one or more animal body parts or one or more combinations thereof. The biological material according to the first or second aspect may include a human body or one or more human body parts (or one or more combinations thereof) and a container. The biological material according to the first or second aspect may include an animal body or one or more body parts (or one or more combinations thereof) and a container. In a specific embodiment, the biological material consists of a human body, one or more human body parts, an animal body, one or more animal body parts (or one or more combinations thereof) and optionally a container.

The method according to present invention comprises several phases. These phases should not be considered separate stages but are (semi)-automatic, gradual phases during the process. These are natural phases that occur during the combustion process but that are tuned by the present invention.

The following phases can be differentiated:

A drying phase when the biological material is heated and water is evaporated from said material. The temperature during this phase is preferably lower than 200° C.

A combustion phase in which the biological material ignites and to allow combustion; the drying phase and the combustion phase may partly overlap since the drying will most likely not be completed when ignition sets in. It should be noted that even during the combustion phase the remaining water will be evaporated but once combustion is ongoing, it is called combustion phase and not drying phase. The temperature during this phase may be between 200 and 800° C.

A cooling phase in which the combusted biological material is allowed to cool (or is actively cooled). This phase may overlap partly with the combustion phase since at the end of the combustion phase the temperature may already decrease somewhat.

In an embodiment a susceptor is present. In such an embodiment, the biological material and the susceptor should be provided in such a manner that they are both present inside the chamber of said apparatus. A microwave absorbing susceptor that may be present, could be present in such a way that it is at least partly occluded from said microwave radiation by said biological material. Said microwave absorbing susceptor may comprise a susceptor material (it may consist of susceptor material); preferably wherein said susceptor material is silicon carbide. The microwave absorbing susceptor may be in the form of tiles. A non-limiting example thereof is that human remains that are positioned on a plurality of tiles of the susceptor which are e.g. located on a tray resting on the base/bottom of the chamber whereas the source of microwave radiation is located near the top/ceiling or at the sides of said chamber. The opaque nature of said biological material is related to the water content thereof: as the water content decreases (due to drying) the opaque level decreases and the transparency to microwave radiation increases, thereby decreasing the occlusion, or attenuation, of the directed energy. As the water content of the biological material decreases, more microwave radiation is able to penetrate the body in order to reach the susceptor that is present underneath. In case the susceptor is present it is at least partly blocked from direct irradiation by the presence of the biological material which is in the line of sight between the susceptor and the source of microwave radiation. In the second step of the method, microwave radiation is directed from the source of microwave radiation to the biological material (leading to directly heating) and—if present—also to the susceptor (leading to indirect heating) to combust said biological material. The first and second phases might overlap as the opaque level gradually decreases during the drying. This means that the irradiation of the susceptor will increase proportionally with the drying of the biological material.

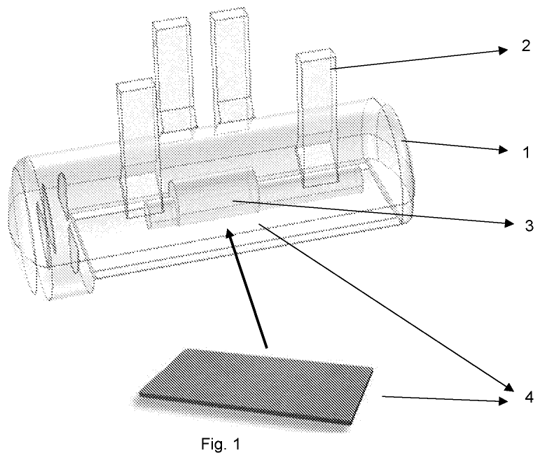

FIG. 1 is a schematic view of an apparatus for use in the present method. Said apparatus comprises a chamber 1 with four waveguides 2 in the depicted embodiment. However, other apparatuses may be used having different layout and different numbers and/or placement of the waveguides. In the chamber 2 the biological material 3 is present in the form of a human body after the death of the human being. In other embodiments, the biological material may be human body parts (e.g. when no intact human body is present by means of an accident. In other embodiments, the biological material may be an animal body after the death thereof or animal body parts (e.g. when no intact animal body is present because of an accident or in case parts of cadavers, e.g. from slaughter houses, need to be combusted). The biological material 3 is resting on a microwave absorbing susceptor 4, which is present in the shape of a tile—as indicated by the sub-figure of the tile in close-up. However, this is merely an embodiment, the susceptor 4 is not required and the biological material can be present without said susceptor. In an embodiment, the biological material is present in a container, such as in a (wooden) coffin/casket, a basket or a shroud. Preferably, the container should be combustible/flammable. Conventional coffins/caskets comprise a lining and cushioning on the inside and well as optional metal hinges and other hardware parts such as nails or screws for closure and handles for carrying. These are all emcompassed in the wording “container” and as such also in the term “biological material” even though strictly speaking the metal hinges and other hardware are in essence not biological.

The method according to the present invention may comprise in step ii) a two-phase process comprising as a first phase the evaporation of water from said biological material to a dried biological material, and as a second phase the ignition of said dried biological material. Both phases take place in the same chamber. Hence, the chamber can—according to this two-phase system—be seen as a dual action chamber: a first action being direct heating by microwaves to reach a drying temperature for the biological material to release water, i.e. to at least partially dry the biological material, and a second action being direct heating by microwaves of the dried biological material (and optionally the susceptor) to reach an ignition temperature to achieve combustion of the dried biologically material.

The biological material (starting material) has a higher level of interaction with the microwave radiation than the dried biological material. As the biological material releases water due to microwave radiation, its dielectric properties change and its molecules are less polarisable. This means that as the biological material releases water (dries) due to the microwave radiation, it becomes more transparent to the microwave radiation.

In an embodiment, the biological material at least partly occludes the microwave absorbing susceptor by being present between the susceptor and said source of microwave radiation by the opaque nature of said biological material.

The effect of irradiating said biological material with microwave radiation is heating of said biological material; leading first to evaporation of at least part of the water of said biological material (called volumetric heating) and then to thermal decomposition of said biological material providing flammable gases.

The effect of irradiating said susceptor with microwave radiation is that the susceptor absorbs this radiation energy and convert it to heat which is re-emitted as thermal radiation; this radiation provides thermal decomposition of said biological material providing flammable gases and in addition provides a sufficiently high temperature to ignite said flammable gases leading to combustion. The mere irradiation of biological material without the presence of a susceptor leads to ignition; but the present inventors have observed that the susceptor can help in achieving that effect in a shorter time span and with a decreased energy consumption. In the embodiment where the susceptor is at least partly occluded from microwave radiation, the susceptor is not (fully) activated until at least part of the water has evaporated thereby avoiding a too high temperature too early in the process, leading to heat-scorching of the biological material and thereby hindering the evaporation of water.

According to the invention, drying and combustion of the biological material take place in the same chamber as a consequence of directing microwave radiation to the biological material and—if present—at least partly to the susceptor. The chamber may be closed. Since the method according to the present invention can take place under a nominal atmospheric pressure (being defined here as atmospheric pressure+/−200 millibar), there is no need for a complete air-tight seal of the chamber. However, the chamber may be sealed air-tight.

In an embodiment, the source of microwave radiation is a single magnetron. In an embodiment, the source of microwave radiation comprises multiple magnetrons.

In general, the temperature to dry the biological material may be below 200° C., preferably between 100 and 150° C. This is to avoid (skin) scorching. In general, the biological material will combust when an ignition temperature of between 400 and 500° C. is reached, preferably between 440 and 460° C., such as 450° C. However, in certain embodiments, that temperature may be significantly lower. The ignition temperature depends on the moisture content: the ignition temperature is lower at a lower moisture content. The ignition temperature also depends on the presence of a container, such as a wooden coffin, which will reduce the overall ignition temperature of the biological material in said coffin. In addition, any metal parts of a container, e.g. metal parts of a coffin may cause sparking when subjected to microwave radiation, further decreasing the ignition temperature. It may even be possible that the ignition temperature is as low as room temperature when a container is used.

The temperature of the chamber may be measured using a thermocouple that is located on the outside of the wall of the chamber. The thermocouple would cause sparks if present inside of the chamber. The temperature of the biological material may be measured using IR temperature sensor or an IP thermometer.

In the present invention, no preheating of the chamber or the biological material is necessary, the combustion process of the present invention can start at room temperature (20-25° C.). If the temperature in the chamber is above room temperature but below the drying temperature of 200° C., for instance due to recent use of the chamber, there is no need to cool the chamber prior to the combustion process of the present invention. The biological material may have been cooled prior to the combustion process. There is no need for the biological material to be heated until room temperature before initiating the combustion process of the present invention.

In an embodiment, the microwave absorbing susceptor comprises a susceptor material. Suitable susceptor materials include silicon carbide, graphite, metal oxides such as zirconium dioxide or magnetite, ferrite, and conductive metals (on glass or ceramic plates). In a preferred embodiment, the susceptor material is silicon carbide.

In an embodiment, the microwave absorbing susceptor is in the form of tiles or powder. The susceptor may expand upon heating. Hence, when the susceptor is in the form of tiles, it is preferable that the tiles are not fixed in their location, but that each tile has room to expand upon being heated.

The susceptor may be present in the chamber before introduction of the biological material, or the susceptor may be introduced into the chamber simultaneously with the biological material, or the susceptor may be introduced into the chamber after introduction of the biological material.

The standard procedure for cremation is often as follows. The biological material (e.g. coffin with human or animal remains) is introduced into the chamber manually or by a mechanical pusher. After combustion of the biological material, the combusted biological material after combustion (ashes, burned bone fragments etc.) is removed from the oven chamber and transported to another room for further handling thereof (e.g. cooling and reduction in particle size of the combusted biological material and packaging thereof (“ashes”)). The combusted biological material, is also referred to as “cremains” or “ashes”. It is not always actual ash but can be unburnt fragments of bone mineral, which are commonly ground down into powder in a cremulator. The terms “cremains” and “ash” may refer to the combusted biological material as well as to the cremulated combusted biological material. The product obtained from the method and process according the present invention are cremains or ashes.

According to the present invention, the biological material (e.g. coffin with human or animal remains) may be placed on top a tray in specific embodiments, for instance a metal tray. In embodiments, it may be advantageous to place the biological material onto the tray outside of the oven chamber, after which the filled tray is introduced into the chamber. If present, the susceptor may be present on the tray beneath the biological material or may be provided within a container for holding the biological material, positioned below said material, e.g. within the base of a coffin. After combustion of the biological material—if a tray is used—said tray holding the combusted biological material (and possibly the susceptors if used) after combustion may be removed from the oven chamber and transported to another room for further handling thereof; after which the tray could be cleaned and re-used. Several trays may be in use simultaneous for a single cremator oven. The use of a tray system can be useful for increasing the ease of handling, however, it is not required.

In an embodiment, the source of microwave radiation is connected to at least one waveguide. Waveguides direct the microwaves towards the chamber; the microwaves spread in the entire volume of the chamber. In a preferred embodiment, the source of microwave radiation is connected to a number of waveguide which allows the maximum energy absorption. For example, the source of microwave radiation is connected to one to six waveguides. For instance, the source of microwave radiation may be connected to one, two, three, four, five or six waveguides. Preferably it is connected to four waveguides. These waveguides can be directed to different parts of the biological material, e.g. when the biological material is a human body or large animal the waveguides can be directed to the head, chest and legs, for instance with two of the waveguides directed to the chest, one to the head and one to the legs in case of a human body or to the head, chest/front legs and back side/back legs in case of a large animal (e.g. horse or large dog). In case the body is small (e.g. an infant body or a small animal, such as a cat or small dog), it is preferred to use only two waveguides. Each of the waveguides present in the apparatus may be individually switched off and on as needed.

The geometry of a waveguide reflects its function. The frequency of the transmitted wave also dictates the size of a waveguide: each waveguide has a cutoff wavelength determined by its size and will not conduct waves of greater wavelength. The waveguides should thus be selected or modified based on the applied frequency/wavelength of microwaves by the source of microwave radiation.

The microwave-absorbing susceptor may be in line-of-sight with the source of microwave radiation or the waveguides, such that the biological material partially occludes energy from reaching the susceptor.

A (microwave) stirrer may be present in the chamber in specific embodiments. The stirrer distributes the (reflections of the) microwave radiation more homogeneously throughout the chamber. Although likely full homogeneity cannot be expected, the stirrer may help to avoid certain ‘hot spots’ of microwave radiation (reflections). The presence of such a stirrer will ensure a more even (uniform) heating of the biological material.

In an embodiment, the microwave radiation directed from the source of microwave radiation to the biological material is of a single frequency. This means that—in this embodiment—during the time that the source of microwave radiation is active, the frequency of the radiation remains the same; the frequency is not changed during the time of application of the radiation.

In an embodiment, the microwave radiation has a frequency between 1 MHz and 3 GHz, such as between 100 MHz and 3 GHz, more in particular between 500 MHz and 1.5 GHz. In a preferred embodiment, the microwave radiation has a frequency between 700 MHz and 1.1 GHz, such as 915 MHz. A longer wavelength (corresponding to a lower frequency) allows for a higher level of penetration of the radiation into the biological material. The microwave frequencies used in microwave ovens are chosen based on regulatory and cost constraints. One regulatory constraint is that they should be in one of the industrial, scientific, and medical (ISM) frequency bands set aside for unlicensed purposes. Consumer microwave ovens work around a nominal 2.45 GHz, corresponding to a wavelength of 12.2 cm, in the 2.4 GHz to 2.5 GHz ISM band, while large industrial/commercial ovens often use 915 MHz, corresponding to a wavelength of 32.8 cm.

In an embodiment, the power of the source of microwave radiation is at least 10 kW, such as between 10 kW and 100 kW.

In an embodiment, the method comprises in step ii) a two-phase combustion process, wherein in a first phase of said combustion process said radiation directly heats said biological material to evaporate water from the biological material and obtain a dried biological material, and wherein in a second phase of said combustion process said radiation heats the biological material to an ignition temperature, to combust said dried biological material and obtain combusted biological material. In this embodiment, the two phases may overlap. In an embodiment, in the first phase the heating takes place at a drying temperature (or until such a drying temperature is reached which is then maintained). In an embodiment, in the second phase the heating takes place at an ignition temperature (or until such an ignition temperature is reached). In a specific embodiment the power of the source of microwave radiation is between 10 and 30 kW in the first phase of step ii) of the method according to the invention. In another specific embodiment, that may be combined with the above specific embodiment, the power of the source of microwave radiation is between 30 and 100 kW in the second phase of step ii) of the method according to the invention. The increase of power between the first and the second phase may be gradually or may be at once.

In an embodiment, the microwave radiation is applied from (source of microwave radiation switched on at) the beginning of step ii) and are applied at least until the point of ignition (at which point the source of microwave radiation can be switched off). The microwave radiation may be applied non-intermittently (in other words, constantly) from the beginning of the first phase at least until the point of ignition. The microwave radiation may however also be applied until combustion is complete, however this is not necessary. Combustion is an exothermic reaction, and while sufficient energy is required to overcome the so-called activation energy for combustion in order to initiate combustion, the heat produced by the combustion reaction itself will in some cases (e.g. when a container is present) provide enough energy to make the reaction self-sustaining. In other embodiments, a susceptor or sustained microwave radiation may be required.

A significant high temperature (ignition temperature) is required to start combustion. The ignition temperature depends on the water content of the biological material. Combustion can also be initiated by the use of a spark to ignite the flammable gases. However, by use of the microwave absorbing susceptor according to the present invention a temperature can be reached that is above the ignition point of the flammable gases produced during thermal decomposition of the biological material. By use of the susceptor according to the invention, a temperature of between 400 and 500° C. can be reached, which is sufficient to ignite the flammable gases.

In one embodiment, the method according to the present invention takes place under atmospheric pressure (atm), defined as 101,325 Pa or 1013.25 millibar or at a pressure that is a few hundred millibar below atmospheric pressure, such as between 800 and 1200 millibar, such as between 900 millibar and 1013.25 millibar. The slight underpressure when using a non-sealed chamber creates a draft or flow in the chamber that allows fresh air to flush through the chamber thereby removing water vapour, which is beneficial during the drying phase. During the drying phase a ventilator, e.g. a cyclone ventilator, may be used to create a flow of air through the chamber thereby removing water vapour, which is beneficial during the drying phase.

In an embodiment, the method according to the present invention takes place in the presence of oxygen. This may be atmospheric oxygen, i.e. the method may take place in the presence of air, which comprises oxygen. The amount of oxygen in air is approximately 21 vol. %. The method of the present invention does not require a vacuum or an inert (oxygen free) atmosphere. This is difference from pyrolysis, since pyrolysis requires an inert atmosphere. The product obtained is different with combustion versus pyrolysis since the chemical reaction is different.

In an embodiment, the combustion process of the invention includes a step of determining the starting weight of the biological material to determine the energy level of the microwave radiation and/or the duration for direction of microwave radiation. The weight of the biological material may be for instance determined by the use of scales, or calculations based on estimated or measured volume of the biological material. The weight of a container (e.g. coffin) may be included in the determined weight of the biological material. It may also be possible to subtract the weight of the container (which may be known from e.g. a catalogue) from the measured weight of the container including the biological material to determine the weight of the biological material without the container.

In general, a cremation process includes a step of cooling the combusted biological material, for instance to room temperature (20-25° C.), this is considered above discussing a cooling phase. This cooling may be active or passive cooling. The cremation process may also include a step of collecting the combusted biological material. The collected combusted biological material may be transferred to a grinder, called cremulator, where it is powdered into a fine grey-white material, ashes. The ashes may then be collected e.g. into an urn.

The microwave absorbing susceptor—if present—does not combust during the combustion process of the invention. In case the susceptor is in the form of tiles or other shapes, the combusted biological material may be separated from the susceptor prior to grinding and transfer of the ashes e.g. into an urn. The susceptor can be reused.

In an embodiment, the biological material includes a human or animal body or body part, and optionally a container. The container is preferably selected from the group consisting of a coffin, a casket (US name for coffin), a basket, and a shroud. More preferably, the container is a coffin.

The container must be at least partially transparent to microwave radiation. The container may be a conventional coffin, as long as it allows microwave radiation to enter the container, and water vapour to exit the container; no special device is required to let the vapour out.

In an embodiment, the container may comprise the microwave absorbing susceptor, preferably below the biological material.

In an embodiment, the biological material is resided on a tray. The biological material may be in a container, which container then is resided on the tray.

In an embodiment, the chamber has a base, wherein—during use—there is a spacing in between the biological material and the base of the chamber to avoid electrical arcing. In case a tray is used, and the tray is in physical contact with the chamber floor (i.e. electrically neutral with the chamber structure), the spacing in this embodiment is between the biological material and the tray. The arcing phenomena can cause unwanted thermal runaway inside the chamber, leading to disruption and malfunctioning of the system. To avoid arcing it is required that the field strength (300 kV/m) needed for arcing will not be reached all along the arcing path. Arcing can occur when the spacing is very small, e.g. between 8 mm and 3 cm. The preferred spacing depends on the system, but it may be for instance preferably at least 3 cm, more preferably at least 5 cm. In a specific embodiment, the microwave absorbing susceptor may be present in the spacing between the biological material and the base of the chamber. This spacing may for example be realised by a false floor (adding a bottom compartment) in the container to raise the biological material within said container from the base of the chamber. The susceptor may for example be present in a bottom compartment of the container. For instance, the container (e.g. a coffin) may have a double bottom dividing the container in two compartments, where the susceptor is present in the bottom compartment and the biological material is present in the top compartment.

In an embodiment, there is a thermal insulation provided between the tray and the susceptor. This serves to protect the tray from conduction heating. This thermal insulation may be a ceramic material with thermal insulation properties. in the form of a tile, e.g. of silicon nitride.

Upon heating, the biological material produces gaseous products due to thermal decomposition. Any gases that leave the chamber may be analyzed, e.g. for oxygen, e.g. at the outlet of the chamber, and/or they may be trapped by chemical reaction or physical transformation.

The present invention relates in a specific embodiment to a method for combustion of a biological material which biological material includes a human or animal body or body part, and optionally a container, by means of microwave radiation, said method comprising the steps of:
i) providing said biological material to be combusted and an apparatus comprising a chamber and a source of microwave radiation; and
ii) directing microwave radiation having a frequency between 1 MHz and 3 GHz from said source of microwave radiation to said biological material in a two-phase combustion process in the presence of oxygen, wherein in a first phase of said combustion process said radiation, having a power of between 10 and 50 kW, heats said biological material to a drying temperature of below 200° C. to evaporate water from the biological material and obtain a dried biological material, and wherein in a second phase of said combustion process said radiation, having a power of between 10 and 50 kW, heats the microwave absorbing susceptor to an ignition temperature to combust said dried biological material and obtain combusted biological material.

The present invention relates in a specific embodiment to a method for combustion of a biological material which includes a human or animal body or body part, and optionally a container, by means of microwave radiation, said method comprising the steps of:
i) providing said biological material to be combusted, a microwave absorbing susceptor and an apparatus comprising a chamber and a source of microwave radiation, in such a manner that said biological material and said susceptor are present in said chamber such that said biological material at least partly occludes said susceptor from microwave radiation; and
ii) directing microwave radiation having a frequency between 1 MHz and 3 GHz from said source of microwave radiation to said biological material and said at least partly occluded susceptor in a two-phase combustion process in the presence of oxygen, wherein in a first phase of said combustion process said radiation heats said biological material to a drying temperature of below 200° C. to evaporate water from the biological material and obtain a dried biological material, and wherein in a second phase of said combustion process said radiation heats the microwave absorbing susceptor to an ignition temperature of between 400 and 500° C., to combust said dried biological material and obtain combusted biological material.

The present invention relates in a specific embodiment to a method for combustion of a biological material which includes a human or animal body or body part, and optionally a container, by means of microwave radiation, said method comprising the steps of:
i) providing said biological material to be combusted, a microwave absorbing susceptor and an apparatus comprising a chamber and a source of microwave radiation, in such a manner that said biological material and said susceptor are present in said chamber such that said biological material at least partly occludes said susceptor from microwave radiation; and
ii) directing microwave radiation having a frequency between 1 MHz and 3 GHz from said source of microwave radiation to said biological material and said at least partly occluded susceptor in a two-phase combustion process in the presence of oxygen, wherein in a first phase of said combustion process said radiation heats said biological material to a drying temperature to evaporate water from the biological material and obtain a dried biological material, and wherein in a second phase of said combustion process said radiation heats the microwave absorbing susceptor to an ignition temperature, to combust said dried biological material and obtain combusted biological material.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope thereof.

### CLAUSES

1. A method for combustion of a biological material by means of microwave radiation, said method comprising the steps of:
   i) providing said biological material to be combusted, a microwave absorbing susceptor and an apparatus comprising a chamber and a source of microwave radiation; and
   ii) directing microwave radiation from said source of microwave radiation to said biological material and said susceptor to combust said biological material.
2. The method according to clause 1, wherein in step i) said biological material and said susceptor are present in said chamber such that said biological material at least partly occludes said susceptor from microwave radiation.
3. The method according to any of the preceding clauses, wherein the microwave absorbing susceptor comprises a susceptor material; preferably wherein said susceptor material is silicon carbide.
4. The method according to any of the preceding clauses, wherein the microwave absorbing susceptor is in the form of tiles.
5. The method according to any one of the preceding clauses, wherein the source of microwave radiation is connected to at least one waveguide directed towards said biological material.
6. The method according to any of the preceding clauses, wherein the microwave radiation directed from said source of microwave radiation to said biological material is of a single frequency.
7. The method according to any of the preceding clauses, wherein the microwave radiation has a frequency between 1 MHz and 3 GHz, preferably between 100 MHz and 3 GHz, more preferably between 500 MHz and 1.5 GHz, most preferably between 700 MHz and 1.1 GHz.
8. The method according to any of preceding clauses, the method comprising in step ii) a two-phase combustion process, wherein in a first phase of said combustion process said radiation heats said biological material to evaporate water from the biological material and obtain a dried biological material, and wherein in a second phase of said combustion process said radiation heats the microwave absorbing susceptor to an ignition temperature, to combust said dried biological material and obtain combusted biological material.
9. The method according to any of the preceding clauses, wherein the microwave radiation is applied from the beginning of step ii) at least until the point of ignition of said biological material.
10. The method according to any of the preceding clauses, wherein the method takes place under atmospheric pressure.
11. The method according to any of the preceding clauses, wherein the method takes place in the presence of oxygen, preferably air.
12. The method according to any of the preceding clauses, including a step of determining the starting weight of the biological material to determine the energy level of the microwave radiation and/or the duration for direction of microwave radiation.
13. The method according to any of the preceding clauses, wherein the biological material includes a human or animal body or body part, and optionally a container.
14. A method for combustion of a biological material according to any one of the preceding clauses which biological material includes a human or animal body or body part, and optionally a container, by means of microwave radiation, said method comprising the steps of:
   i) providing said biological material to be combusted, a microwave absorbing susceptor and an apparatus comprising a chamber and a source of microwave radiation, in such a manner that said biological material and said susceptor are present in said chamber such that said biological material at least partly occludes said susceptor from microwave radiation; and
   ii) directing microwave radiation having a frequency between 1 MHz and 3 GHz from said source of microwave radiation to said biological material and said at least partly occluded susceptor in a two-phase combustion process in the presence of oxygen, wherein in a first phase of said combustion process said radiation heats said biological material to a drying temperature of below 200° C. to evaporate water from the biological material and obtain a dried biological material, and wherein in a second phase of said combustion process said radiation heats the microwave absorbing susceptor to an ignition temperature of between 400 and 500° C., to combust said dried biological material and obtain combusted biological material.
15. A process for cremating a human or animal body or body part comprising the method of any of the preceding clauses.
16. A method for cremating a human or animal body or body part comprising the method of any of the preceding clauses.
17. A method for combustion of a biological material by means of microwave radiation, said method comprising the steps of:
   i) providing said biological material to be combusted and an apparatus comprising a chamber and a source of microwave radiation; and
   ii) directing microwave radiation from said source of microwave radiation to said biological material to combust said biological material.

These clauses show several aspects and embodiments of the present invention.

### EXAMPLES

The present invention is further elucidated based on the Examples below which is illustrative only and not considered limiting to the present invention.

### Example 1—Body Parts of a Pig in Small-Scale Microwave

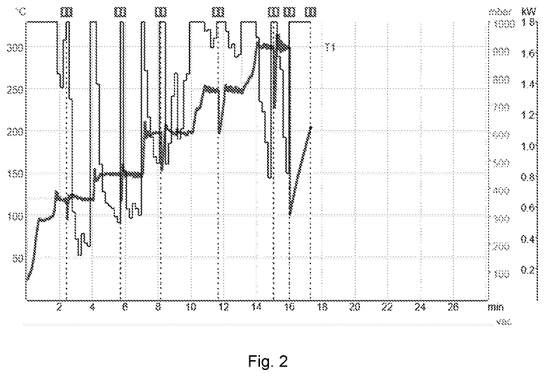

The experiments for this example were conducted in a small-scale microwave (maximum power input 1.8 kW) on samples of body parts (flesh) of a pig. The example shows the temperature evolution of biological material when subjected to microwave radiation. FIG. 2 shows the results. The temperature was measured using a thermocouple. The thick line in FIG. 2 shows the temperature evolution of the meat when the thermocouple is placed inside the meat sample (approximately in the centre of the sample). It was observed that after 1 minute the temperature in the centre reached 100° C. and the surface water evaporated. The chamber was full of vapour and the meat was thermally denatured. After approximately 2 minutes the sample centre reached 120° C. It was not possible to evaporate all the water at 100° C. and higher temperature and a longer timeframe were required. Without wishing to be bound by theory, the inventors believe that this is due to the high-water content, the limited diffusivity in the meat pores and the lockage due to scorching. After 5 minutes the centre of the meat reached approximately 150° C. The meat looked well on the way to full conbustion and the temperature remained constant for a few minutes. After 8 minutes the sample reached 200° C. and the meat started to melt in a dense and viscous black liquid. The complex molecules of the meat, for instance the amino acids, started to decompose towards less complex compounds. The melting phase continued and after approximately 15 minutes, the sample reached 300° C., but it was not fully carbonized. By increasing the temperature and the experimental time, it was possible to observe ignition at approximately 400° C. (not shown FIG. 2). The combustion afterwards was sustained by the high calorific value of the fats present.

### Example 2—Whole Baby Pig (Piglet) Full-Scale Microwave

In this example, no susceptor material nor container was present. A whole baby pig (piglet) was used as the biological material.

Overall, it was observed that the process evolution was as follows, which is the same for the following examples including a susceptor and/or container.

At first, the biological material goes through a drying stage, in which the organic matter absorbs all the power input due to the high-water content (approximately 10 minutes). Secondly, the biological material starts charring. This step of the process lasts approximately 10 minutes, until the full biological material is transformed into a biochar. Once the entire biological material is charred, ignition occurs. After ignition, a strong interaction between microwaves and flames is visible. The process continues aided with microwaves for another hour approximately (depending on the biological material load), until the flame size reduces drastically and few combustible matter is left in the chamber. At this point, the microwaves are switched off and the process continues with natural combustion aided by air followed by cooling.

This example relates to the combustion of a whole pig of 14 kg (including head, bones and skin). The pig was subjected to microwaves having a power of 30 kW for approximately one hour and 10 minutes and afterwards the power was reduced to microwaves having a power of 15 kW for approximately 10 minutes (due to unwanted arcing phenomena). Afterwards, the microwave input was switched off and the natural combustion continued.

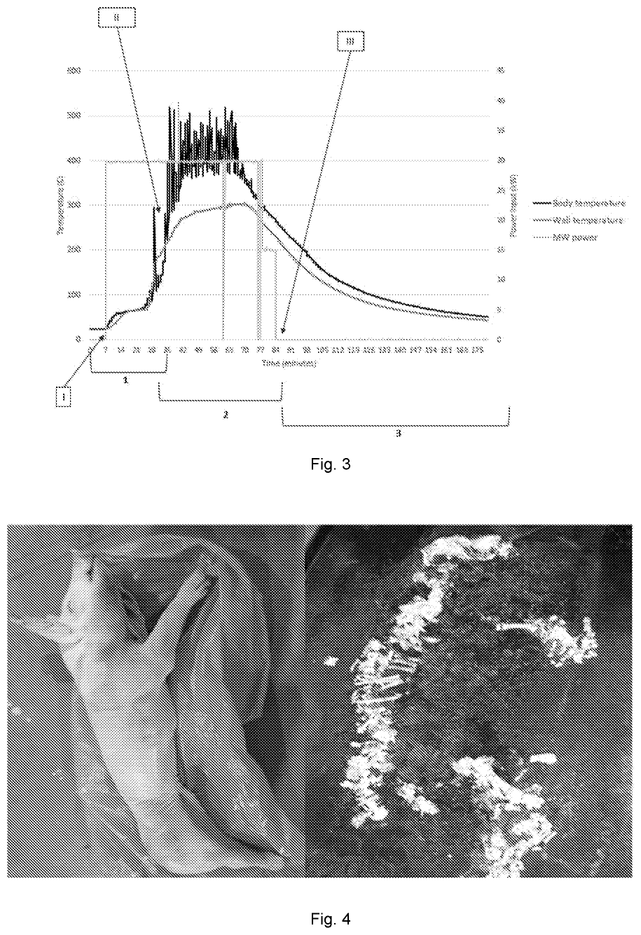

FIG. 3 shows a graph in which the temperature in ° C. is plotted on the left Y-axis, the microwave power input in kW is plotted on the right Y-axis and time in minutes is plotted on the X-axis. Three different curves are shown, being a black curve for the temperature of the biological material which is measured using infrared temperature sensing, the dark grey curve for the temperature of the wall of the chamber which is measured using a thermocouple placed on the outer wall of the chamber, and light grey for the microwave power that is applied.

The arrows with roman numeral depict the following in each of the graphs: I=start of microwave radiation thereby initiating the drying phase; II=start of combustion phase; III=switching of microwave power; IV=effect of susceptor.

Arrow I is the start of application of microwave radiation to 30 kW, which is after 7 minutes. Directly thereafter it was observed that the temperature of both the chamber wall as well as the biological material increased. The brackets below the X-axis, denoted 1, 2, and 3 show the different phases or stages that occur during the process, being a drying phase (1), a combustion phase (2) and a cooling phase (3).

After somewhat less than 30 minutes there is a first spark, which is visible as a sharp increase in temperature. After approximately 35 minutes combustion truly starts (see arrow II) and the temperature rises further to approximately 400° C. in the biological materials with oscillations up to 500° C. due to the flames and to approximately 300° C. for the chamber wall. After approximately 75-80 minutes the microwaves are switched off (see arrow III), after which the combustion phase ends and the cooling phase starts. The microwave power is shortly decreased to 15 kW and afterwards at around 85 minutes the microwave power is stopped and the chamber and combusted material is allowed to cool to room temperature over a period of approximetaly 100 additional minutes.

FIG. 4 shows two photographs, the first of the whole baby pig prior to entry into the chamber. NB. The plastic wrapping is not added to the chamber. The second photograph shows the remains, including bone fragments of the whole baby pig.

### Example 3—Body Parts (Shoulders) of a Pig in Coffin with Three Suspectors in Full-Scale Microwave

Example 3 was carried out to see the effect of the presence of a coffin and susceptors. As a result, it was seen that the wooden coffin and the susceptors speed up the overall process. With the coffin and susceptors, the temperature in the chamber is higher leading to a better combustion. Therefore, it is possible to conclude that the process can be performed with microwave input alone, however both the wooden coffin and the susceptor material enhance the combustion.

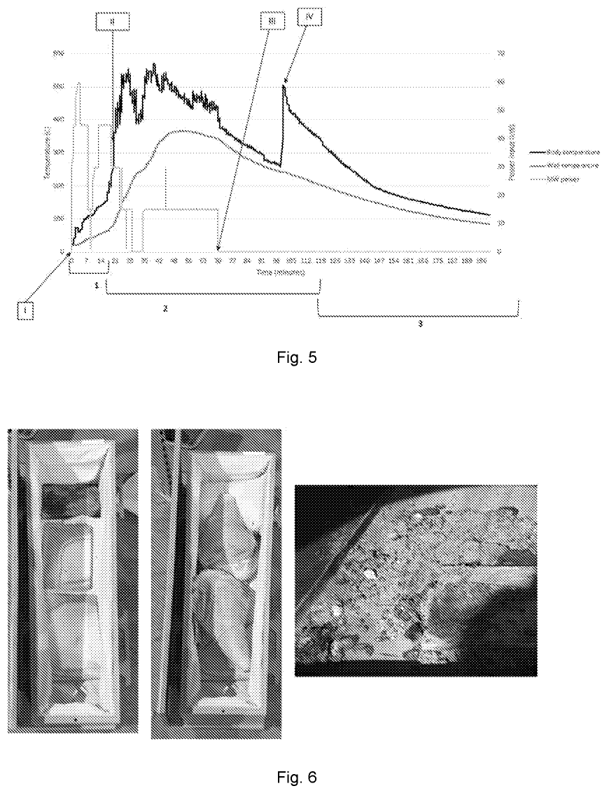

FIG. 5 shows a graph in which the temperature in ° C. is plotted on the left Y-axis, the microwave power input in kW is plotted on the right Y-axis and time in minutes is plotted on the X-axis. Three different curves are shown, being a black curve for the temperature of the biological material which is measured using infrared temperature sensing, the dark grey curve for the temperature of the wall of the chamber which is measured using a thermocouple placed on the outer wall of the chamber, and light grey for the microwave power that is applied. Body parts (shoulders) of a pig, said parts having a total weight of 8 kg, a wooden coffin having a weight of 15 kg and three susceptors, each of 500 g of silicon carbide are being used in this Example.

Arrow I is the start of application of microwave radiation to 40 kW, which is at 0 minutes. In order to avoid arcing the power was increased gradually by increasing it with 5 kW every 10 second. Directly thereafter it was observed that the temperature of both the chamber wall as well as the biological material increased, the temperature of the biological material increases faster. The brackets below the X-axis, denoted 1, 2, and 3 show the different phases or stages that occur during the process, being a drying phase (1), a combustion phase (2) and a cooling phase (3).

After approximately 20 minutes combustion starts (see arrow II) and the microwave power is decreased to 10 kW; the temperature rises further to approximately 400° C. in the biological materials with oscillations up to 550° C. due to the flames and to approximately 350° C. for the chamber wall. After approximately 70 minutes the microwave power is switched off (arrow III) and the temperature decreases and after approximately 100 minutes there is a sharp increase in temperature of merely the biological material. This is the effect of the three susceptors (arrow IV) that become less occluded by the biological material and these susceptors are hence irradiation by microwaves, which leads to a fast temperature increase. After approximately 120 minutes the combustion phase ends and the cooling phase starts. The chamber and combusted material is allowed to cool to room temperature over a period of approximetaly 80 additional minutes.

FIG. 6 shows several photographs, the bottom left of the susceptors in the coffin prior to adding the body parts (shoulders) of a pig, the top left of the body parts in the coffin prior to entry into the chamber. The remaining photographs show the remains.

### Example 4—Whole Baby Pig (Piglet) in Coffin in Full-Scale Microwave

In this example, no susceptor material was present. A whole baby pig in a wooden coffin was used as the biological material.

This example relates to the combustion of a whole pig of 14 kg (including head, bones and skin). The pig was subjected to microwaves having a power of 30 kW starting at 0 minutes (arrow I), starting for the drying phase. Around 13 minutes the temperature increases to a value of 200° C. and after approximately 18 minutes a temperature over 400° C. is reached and combustion starts (arrow II). At approximately minutes the microwave input was decreased to 15 kW and this was continued until approximately 125 minutes. No increase in microwave is applied after 70 minutes; however, the peak in the body temperature was caused by opening the vessel and “raking” the embers inside, causing a localised stronger flame. At approximately 125 minutes the microwaves are switched off (arrow III) and the natural combustion continued until approximately 170 minutes after which the cooling phase starts.

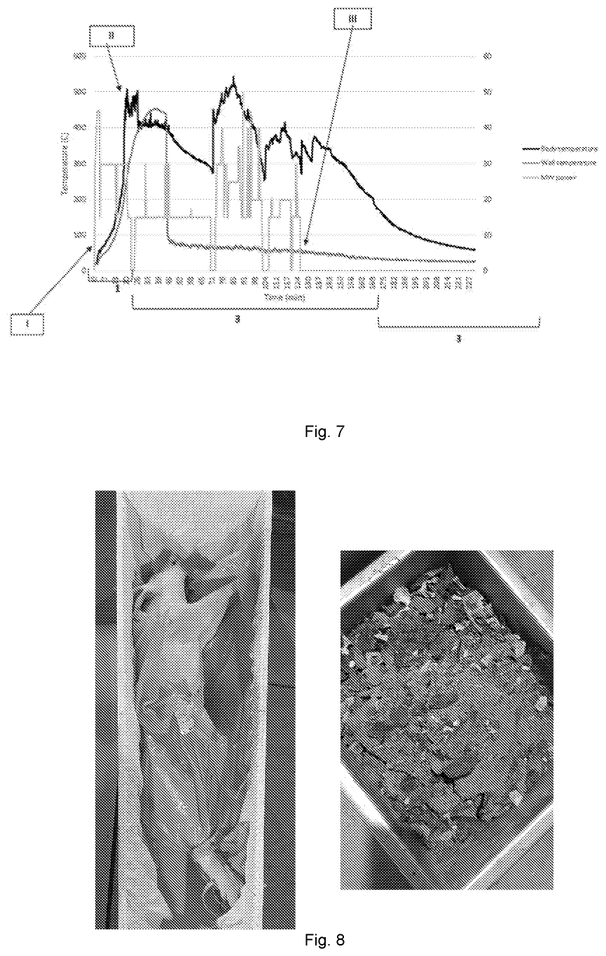

FIG. 7 shows a graph in which the temperature in ° C. is plotted on the left Y-axis, the microwave power input in kW is plotted on the right Y-axis and time in minutes is plotted on the X-axis. Three different curves are shown, being a black curve for the temperature of the biological material which is measured using infrared temperature sensing, the dark grey curve for the temperature of the wall of the chamber which is measured using a thermocouple placed on the outer wall of the chamber, and light grey for the microwave power that is applied. Please note that at minutes the thermocouple broke, giving rise to the sharp decrease in the value for the temperature of the wall of the chamber.

The arrows indicate certain important points in the process, wherein I is the start of application of microwave radiation, Ill is the start of combustion and IV is the end of combustion. The brackets below the X-axis, denoted 1, 2, and 3 show the different phases or stages that occur during the process, being a drying phase (1), a combustion phase (2) and a cooling phase (3).

FIG. 8 shows two photographs, the first of the whole baby pig in a coffin prior to entry into the chamber. NB. The plastic wrapping is not added to the chamber. The second photograph shows the remains after the process is complete.

The scope of the present invention is defined by the appended claims. One or more of the objects of the invention are achieved by the appended claims and the above clauses.

1. A method for combustion of a biological material by means of microwave radiation, said method comprising the steps of:
i) providing said biological material to be combusted and an apparatus comprising a chamber and a source of microwave radiation in such a manner that said biological material is present in said chamber;
wherein the biological material includes a human or animal body or body part, and optionally a container;
ii) directing microwave radiation at a power of at least 5 kW from said source of microwave radiation to said biological material to directly heat and combust said biological material in said chamber.

2. The method according to claim 1, wherein in step i) a microwave absorbing susceptor is provided and wherein said biological material and said susceptor are present in said chamber such that said biological material at least partly occludes said susceptor from microwave radiation.

3. The method according to claim 1, wherein the source of microwave radiation is connected to at least one waveguide wherein a flow of gas is directed down the at least one waveguide during step ii).

4. The method according to claim 4, wherein the flow of gas has a flow rate of at least 10 litres per second per waveguide.

5. The method according to claim 1, wherein the microwave radiation directed from said source of microwave radiation to said biological material is of a single frequency.

6. The method according to claim 1, wherein the microwave radiation has a frequency between 1 MHz and 3 GHz, preferably between 100 MHz and 3 GHz, more preferably between 500 MHz and 1.5 GHz, most preferably between 700 MHz and 1.1 GHz.

7. The method according to claim 1, the method comprising in step ii) a two-phase combustion process, wherein in a first phase of said combustion process said radiation directly heats said biological material to evaporate water from the biological material and obtain a dried biological material, and wherein in a second phase of said combustion process said radiation directly heats the dried biological material to an ignition temperature, to combust said dried biological material and obtain combusted biological material.

8. The method according to claim 1, wherein the microwave radiation is applied from the beginning of step ii) at least until the point of ignition of said biological material.

9. The method according to claim 7, wherein the microwave radiation remains on during combustion.

10. The method according to claim 7, wherein the microwave radiation is switched off after ignition, wherein said biological material comprises a human or animal body or body part and a container.

11. The method according to claim 1, including a step of determining the starting weight of the biological material to determine the energy level of the microwave radiation and/or the duration for direction of microwave radiation.

12. The method according to claim 1, wherein the biological material consists of a human body, an animal body, one or more human body parts, or one or more animal body parts, optionally in a container.

13. A method for combustion of a biological material that includes a human or animal body or body part, and optionally a container, by means of microwave radiation, said method comprising the steps of:
i) providing said biological material to be combusted and an apparatus comprising a chamber and a source of microwave radiation; and
ii) directing microwave radiation having a frequency between 1 MHz and 3 GHz from said source of microwave radiation to said biological material in a two-phase combustion process in the presence of oxygen, wherein in a first phase of said combustion process said radiation having a power of between 10 and 50 kW heats said biological material to a drying temperature of below 200° C. to evaporate water from the biological material and obtain a dried biological material, and wherein in a second phase of said combustion process said radiation having a power of between 10 and 50 kW heats the microwave absorbing susceptor to an ignition temperature to combust said dried biological material and obtain combusted biological material.

14. A method for combustion of a biological material that includes a human or animal body or body part, and optionally a container, by means of microwave radiation, said method comprising the steps of:
i) providing said biological material to be combusted, a microwave absorbing susceptor and an apparatus comprising a chamber and a source of microwave radiation, in such a manner that said biological material and said susceptor are present in said chamber such that said biological material at least partly occludes said susceptor from microwave radiation; and
ii) directing microwave radiation having a frequency between 1 MHz and 3 GHz from said source of microwave radiation to said biological material and said at least partly occluded susceptor in a two-phase combustion process in the presence of oxygen, wherein in a first phase of said combustion process said radiation heats said biological material to a drying temperature of below 200° C. to evaporate water from the biological material and obtain a dried biological material, and wherein in a second phase of said combustion process said radiation heats the microwave absorbing susceptor to an ignition temperature of between 400 and 500° C., to combust said dried biological material and obtain combusted biological material.

15. The method of claim 14, wherein the method is used to cremate the human or animal body or body part.
